(19) United States
(12) Patent Application Publication
(10) Pub. No.: US 2010/0102924 A1
(43) Pub. Date: Apr. 29, 2010

(54) REMOTE CONTROL SYSTEM AND A METHOD OF CONTROL

(75) Inventors: Ronald King, Brownstown, MI (US); Riad Ghabra, Dearborn Heights, MI (US); John Nantz, Brighton, MI (US); Bryan Vartanian, Livonia, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/258,665

(22) Filed: Oct. 27, 2008

(51) Int. Cl. H04Q 1/00

(52) U.S. Cl. 340/5.1; 340/825.69

(57) ABSTRACT

A remote control system and a method of control. The system includes a control module that facilitates execution of a set of functions, a remote control device that wirelessly communicates with the control module, and an input signal. The input signal is provided to the control module and includes data that is associated with ambient lighting. Polling of the remote control device by the control module is deactivated for a subset of the set of functions when the data is indicative of sufficient ambient lighting.

### BACKGROUND OF THE INVENTION

### Field of the Invention

The present invention relates to a remote control system and a method of control.

### SUMMARY OF THE INVENTION

In at least one embodiment, a remote control system is provided. The system includes a control module that facilitates execution of a set of functions, a remote control device that wirelessly communicates with the control module, and an input signal. The input signal is provided to the control module and includes data that is associated with ambient lighting. Polling of the remote control device by the control module is deactivated for commands associated with a subset of the set of functions when the data is indicative of a sufficient level of ambient lighting.

In at least one embodiment, a method of remotely controlling a function is provided. The method includes providing a remote control and a control module that wirelessly communicates with the remote control, providing data indicative of ambient lighting to the control module, and disabling a polling strategy when the data is indicative of sufficient ambient lighting.

In at least one other embodiment, a method of remotely controlling a function is provided. The method includes providing a key fob and a control module that wirelessly communicates with the key fob, providing data associated with ambient lighting to the control module, disabling a polling strategy executed by the control module to reduce power consumption by the control module when the data is indicative of a sufficient level of ambient light, and enabling a polling strategy when the data is not indicative of a sufficient level of ambient light.

### BRIEF DESCRIPTION OF THE DRAWINGS

FIG. 1 is a schematic of an exemplary system for remotely controlling a function.

FIG. 2 is a flowchart of an exemplary method of control that may be exercised with the system.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

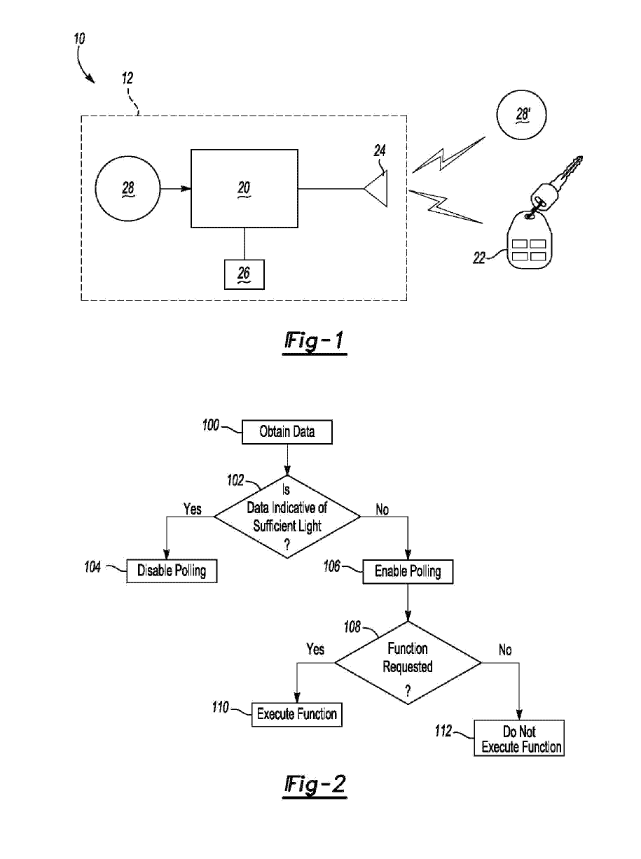

Referring to FIG. 1, an exemplary remote control system 10 is shown. The system 10 may be adapted to remotely control one or more functions as will be discussed in more detail below. The system 10 may be configured for use with a vehicle 12, such as a motor vehicle like a car or truck. For example, the system 10 may be configured as a remote keyless entry system for a motor vehicle. Although the system 10 is primarily described in a vehicle context, it is contemplated that the invention may be implemented to control any appropriate function in connection with any appropriate system and/or device.

The system 10 may have active and/or passive functionality. Active functionality may be initiated when an operator requests a desired function, such as by actuating an input device like a switch or button on a remote control device. Passive functionality may not be initiated or performed in response to an operator request. Instead, a function may be automatically performed in response to the location or movement of the remote control device with respect to a receiver. For instance, in an embodiment having a vehicle-mounted receiver, a vehicle door may be automatically unlocked when the remote control device is brought sufficiently close to the vehicle and may be automatically locked as the remote control device moves away from the vehicle. In a vehicular context, a system capable of passively executing one or more functions is referred to as a passive entry system.

The exemplary system 10 shown in FIG. 1 may include at least one control module 20, a remote control device 22, at least one antenna 24, at least one controlled device 26, and at least one data source 28, 28′,

In FIG. 1 one or more control modules 20 are represented by a single icon; however, functionality may be distributed between multiple controllers and or control circuits that may cooperate to execute, monitor, and/or control one or more functions or operations. In a vehicular example, functionality may be distributed between different modules, such as a body control module and a passive entry/passive start module or integrated into a single module.

The control module 20 may be configured to communicate with and/or control one or more devices. For example, the control module 20 may wirelessly communicate with the remote control device 22. Such communication may include transmitting signals to and/or receiving signals from the remote control device 22. As such, the control module 20 may be electrically connected to one or more antennas 24 that facilitate wireless communication. The control module 20 may also be adapted to decode, demodulate, or decipher a wireless electronic signal received from the remote control device 22 or a portion thereof so that a requested function may be determined.

The control module 20 may also be electronically coupled to one or more systems or devices that may execute a function. For example, the control module 20 may provide an output signal to one or more devices 26 to control execution of a set of functions. In a vehicular context, such a set of functions may include, but are not limited to, actuating a window such as a side window or a roof window (e.g., sunroof or moonroof), actuating a vehicle closure (e.g., door or convertible top), actuating a locking mechanism for a vehicle closure like a door or trunk, and operating an ignition system, alarm system, and/or interior or exterior lights.

The remote control device 22 may have any suitable configuration. For instance, the remote control device 22 may be configured as a handheld remote control unit, which may be called a “fob” or “key fob” in a vehicular context. The remote control device 22 may include a transmitter or suitable electronic device capable of generating the wireless electronic signal, such as a transponder, transceiver, or the like. The transmitter may generate the wireless electronic signal at one or more power levels and at one or more frequencies or frequency deviations as is known by those skilled in the art. The remote control device 22 may include one or more input devices, such as buttons, switches, or sensors, and may include a display screen in one or more embodiments of the present invention.

Data may be provided to the system from one or more data sources. In FIG. 1, two exemplary data sources 28, 28′ are shown. Data source 28 represents data or a data source that may be provided with a vehicle 12. Data source 28′ represents data or a data source that may not be provided with the vehicle 12. Data or a data source that may be provided with a vehicle 12 may include, but not be limited to, data from a sensor, memory, or circuit disposed on the vehicle 12. Data or a data source that may not be provided with the vehicle 12 may include data from a source external to the vehicle 12. Such external data may be wirelessly transmitted to the vehicle 12 and may originate with or be associated with a radio transmission, global positioning system, cell phone, Internet, or other external source. Data from either data source 28, 28′ may be provided as an electrical signal or portion of a signal.

One or more data sources 28, 28′ may provide data associated with ambient lighting. Such data may measure, approximate, estimate, or be used as a surrogate for ambient lighting in the vicinity of the system 10. For brevity, all such data is referred to as being associated with ambient lighting herein. Data associated with ambient lighting may be provided from data source 28 and/or 28′. Ambient lighting data provided from a data source 28 disposed on a vehicle may include data from a light sensor or time data that may be provided by a clock, timer, or navigation system. Data from a light sensor may directly detect an amount of ambient light near a vehicle 12. Such a light sensor may also be used to help control operation of vehicle headlights and/or an automatic interior temperature control system. Data from a clock or navigation system may be associated with a time of day. A time of day may be indirectly associated with an amount of ambient light near a vehicle 12. As such, a predetermined time range may be associated with “daytime” or an elevated amount of ambient light and another time range may be associated with “nighttime” or insufficient ambient light. Moreover, time data may be further refined by cross referencing time data with location data, date data, and/or sunrise/sunset data for a particular location and/or date.

Referring to FIG. 2, a flowchart of an exemplary method of control is shown. As will be appreciated by one of ordinary skill in the art, the flowchart represents control logic which may be implemented using hardware, software, or a combination of hardware and software. The control logic may be implemented using any of a number of known programming or processing techniques or strategies and is not limited to the order or sequence illustrated. For instance, interrupt or event-driven processing may be employed in real-time control applications, rather than a purely sequential strategy as illustrated. Likewise, pair processing, multitasking, or multi-threaded systems and methods may be used to accomplish the objectives, features, and advantages of the present invention.

This invention is independent of the particular programming language, operating system processor, or circuitry used to develop and/or implement the control logic illustrated. Likewise, depending upon the particular programming language and processing strategy, various functions may be performed in the sequence illustrated at substantially the same time or in a different sequence while accomplishing the features and advantages of the present invention. The illustrated functions may be modified or in some cases omitted without departing from the spirit or scope of the present invention.

At 100, data is obtained that may be associated with ambient light in the vicinity of the system. The data may be provided by the one or more data sources 28, 28′ and may be based on or contain data that is internal or external to a vehicle 12 as previously discussed.

At 102, a determination is made whether the data is indicative of a sufficient ambient light. Such a determination may be made in various ways. For instance, data from a light sensor may be compared to a predetermined threshold value to determine if a sufficient level of ambient light is present. Alternatively, data associated with time, date, and/or location may be compared to predetermined data, such as data in a lookup table, to determine or approximate whether the system is operating in daytime or nighttime conditions as previously discussed. In addition, data from an external source that provides weather or cloud cover conditions may also be employed. If the data is indicative of sufficient ambient light, then the method continues at block 104 where a polling strategy is disabled. If the data is not indicative of sufficient ambient light, then the method continues at block 106 where a polling strategy is enabled.

Various polling strategies may be disabled or enabled in association with blocks 104 and 106. For example, a low frequency polling strategy may be selectively employed in which the control module transmits or initiates the transmission of a signal that queries for a remote control device 22 within a signal transmission range. A signal may be periodically sent when the polling strategy is enabled.

The polling strategy may be associated with a subset of the set of functions that the control module 20 may control or execute. For instance, some functions may not be beneficial or desired when sufficient ambient light is present. An example of such a function is turning on interior or exterior vehicle lights when there is sufficient ambient light. As such, there is no need to execute a polling strategy to determine if a remote control device is present and whether interior or exterior lights should be turned on. Functions whose control or implementation may be desired or undesired as a function of estimated or actual ambient light levels may be categorized as a subset of the set of functions that the control module may control, monitor, and/or execute. Thus, a polling strategy that sends a signal to determine the presence of the remote control device may be disabled for a subset of functions that are not desired when sufficient ambient light is present. Disabling execution of the polling strategy may help reduce power consumption by the control module 20 and thereby reduce draining of an electrical power source such as a battery.

At 108, a determination is made as to whether a function is requested. A function may be requested with or without operator input (i.e., actively or passively) in one or more embodiments as previously discussed. If a function is requested, then the method continues at block 110 and the function is executed. If a function is not requested, then the method continues at block 112 and the function is not executed. Execution may be facilitated or initiated by a signal from the control module 20.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A remote control system, comprising:
a control module that facilitates execution of a set of functions;
a remote control device that wirelessly communicates with the control module; and
an input signal that is provided to the control module, the input signal including data that is associated with ambient lighting;
wherein polling of the remote control device by the control module is deactivated for commands associated with a subset of the set of functions when the data is indicative of a sufficient level of ambient lighting.

2. The system of claim 1 wherein polling of the remote control device by the control module is activated for commands associated with a subset of the set of functions when the data is not indicative of a sufficient level of ambient lighting.

3. The system of claim 1 wherein the remote control device is a key fob.

4. The system of claim 1 wherein the input signal is provided by a light sensor.

5. The system of claim 1 wherein the input signal is provided by a clock.

6. The system of claim 1 wherein the remote control device is a passive entry key fob and the control module is disposed on a vehicle.

7. The system of claim 6 wherein the input signal includes data that is wirelessly communicated to the vehicle.

8. The system of claim 1 wherein the data is indicative of a time of day.

9. A method of control for a remote control system, the method comprising:
providing a remote control and a control module that wirelessly communicates with the remote control;
providing data indicative of ambient lighting to the control module; and
disabling a polling strategy when the data is indicative of sufficient ambient lighting.

10. The method of claim 9 further comprising enabling the polling strategy when the data is not indicative of sufficient ambient lighting.

11. The method of claim 9 wherein the data is based on a time of day.

12. The method of claim 9 wherein the data is provided by a light sensor.

13. The method of claim 9 wherein the control module is disposed on a vehicle and the data is transmitted to the vehicle from a source other than the remote control.

14. The method of claim 9 wherein the polling strategy is associated with a subset of a set of functions, wherein the subset includes at least one of operation of a vehicle lighting system, actuation of a window, and positioning of a seat.

15. A method of control for a remote control system, comprising:
providing a key fob and a control module that wirelessly communicates with the key fob;
providing data associated with ambient lighting to the control module;
disabling a polling strategy executed by the control module to reduce power consumption by the control module when the data is indicative of a sufficient level of ambient light; and
enabling a polling strategy when the data is not indicative of a sufficient level of ambient light.

16. The method of claim 15 wherein the data associated with ambient lighting is provided by a light sensor disposed on a motor vehicle.

17. The method of claim 15 wherein enabling the polling strategy further comprises executing a function based on a command signal transmitted from the key fob to the control module when the command signal is indicative of a function requested by a user.

18. The method of claim 15 wherein enabling the polling strategy further comprises executing a function when the key fob is within a predetermined range of the control module.

19. The method of claim 15 wherein the data associated with ambient lighting is provided by at least one of a cell phone, a radio, a global positioning system, or a clock.

20. The method of claim 15 wherein enabling the polling strategy further comprises activating a light when the key fob is within the predetermined range of the control module.
